(19) United States
(12) Patent Application Publication
(10) Pub. No.: US 2025/0089121 A1
(43) Pub. Date: Mar. 13, 2025

(54) MULTI-LINK PROCEDURE TO IDENTIFY LINK DISABLEMENT IN BASIC SERVICE SET (BSS) TRANSITION MANAGEMENT FRAMES

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 18/828,930

(22) Filed: Sep. 9, 2024

Related U.S. Application Data
(60) Provisional application No. 63/581,467, filed on Sep. 8, 2023.

(51) Int. Cl. H04W 76/20; H04W 76/30; H04W 76/40

(52) U.S. Cl. CPC H04W 76/20; H04W 76/30; H04W 76/40

(57) ABSTRACT

A multi-link procedure to identify link disablement in Basic Service Set (BSS) transition management frames may be provided. First, a Basic Service Set (BSS) Transition Management (BTM) request may be created. The BTM request may indicate a link disablement that will happen in the future. Then the BTM request may be sent.

### RELATED APPLICATION TECHNICAL FIELD

Under provisions of 35 U.S.C. § 119 (e), Applicant claims the benefit of U.S. Provisional Application No. 63/581,467 filed Sep. 8, 2023, which is incorporated herein by reference.

### TECHNICAL FIELD

The present disclosure relates generally to providing multi-link procedure to identify link disablement in Basic Service Set (BSS) transition management frames.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing multi-link procedure to identify link disablement in Basic Service Set (BSS) transition management frames;

FIG. 2 is a flow chart of a method for providing multi-link procedure to identify link disablement in Basic Service Set (BSS) transition management frames;

FIG. 3 illustrates a Request Mode field format; and

FIG. 4 is a block diagram of a computing device.

### DETAILED DESCRIPTION

### Overview

A multi-link procedure to identify link disablement in Basic Service Set (BSS) transition management frames may be provided. First, a Basic Service Set (BSS) Transition Management (BTM) request may be created. The BTM request may indicate a link disablement that will happen in the future. Then the BTM request may be sent.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In the Institute of Electrical and Electronics Engineers (IEEE) 802.11be draft amendment, when an affiliated AP is getting removed from an AP Multi Link Service (MLD), the Basic Service Set (BSS) Transition Management (BTM) Request frame may be sent by the affiliated AP being removed to notify legacy client devices (i.e., Stations (STAs)) (pre-11be STAs) that the BSS corresponding to the AP will be terminated. For Extremely High Throughput (EHT) non-AP MLDs, a Link Removal Imminent bit was added in the BTM Request to signal that only the affiliated

AP is shutting down, and the AP MLD that has multiple affiliated APs will continue to operate on the remaining affiliated APs. If a broadcast BTM Request is sent, the Link Removal Imminent bit is needed for the EHT non-AP MLDs to determine that the BTM is for removal of a link/affiliated AP and not for the removal of the entire AP MLD.

The IEEE 802.11be draft amendment may also define another mechanism to disable a link corresponding to an affiliated AP for a period of time using the advertised Traffic Identifier (TID)-To-Link Mapping mechanism. When an affiliated AP/link is disabled, the BTM Request may be sent out (e.g., either broadcast or unicast) to notify legacy client devices (e.g., pre-11be STAs) that the corresponding BSS is getting terminated (e.g., for legacy devices). If the BTM Request is sent as broadcast, the non-AP MLDs receiving the BTM request may need to have a way to identify that the link corresponding to the AP is getting disabled for a period of time verses: i) the AP/link is getting removed (already addressed by the Link Removal Imminent bit); or ii) the entire AP MLD is shutting down (already addressed by the original BTM request).

This may be because the behavior for non-AP MLDs is different for link disablement and AP removal. In the case of link disablement, the non-AP MLDs maintain the group keys for the disabled ink, to be able to operate on that link when it is enabled back later. Also, a non-AP MLD having two links setup may decide to reassociate to another AP MLD if a link is getting removed (to maintain Multi Link (ML) operation), but it may decide to stay with the current AP MLD if a link is getting disabled for a short duration. Accordingly, embodiments of the disclosure may provide a process for the AP MLD to indicate in the BTM Request frame that a particular link is being disabled and differentiate it from the link being removed.

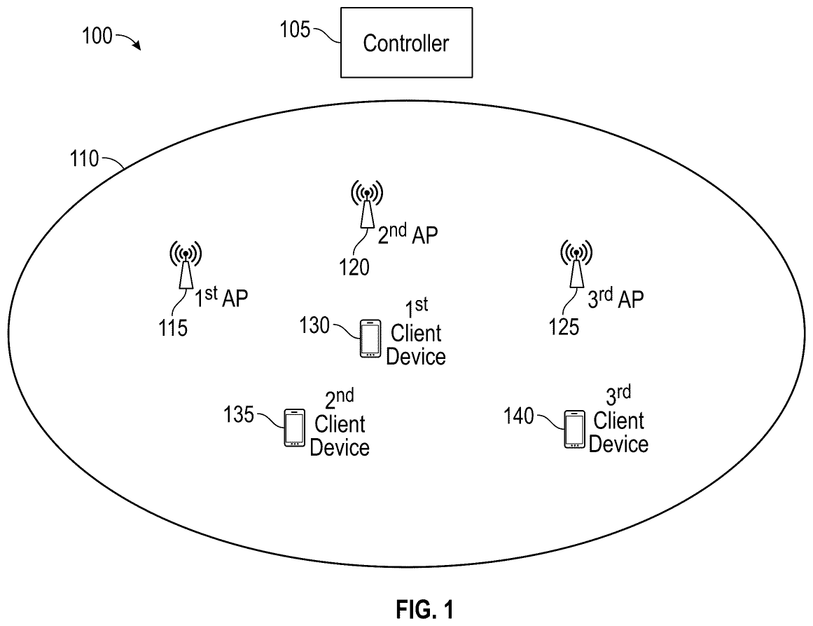

FIG. 1 shows an operating environment 100 for providing a multi-link procedure to identify link disablement in Basic Service Set (BSS) transition management frames. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. The plurality of APs may provide wireless network access to a plurality of client devices as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide a multi-link procedure to identify link disablement in Basic Service Set (BSS) transition management frames.

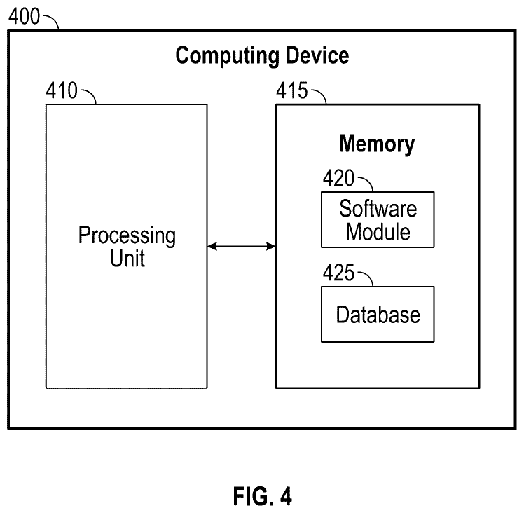

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

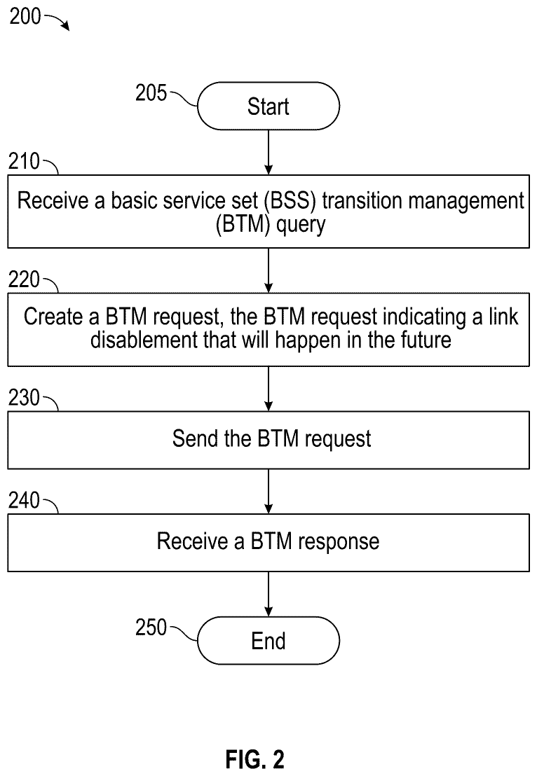

FIG. 2 is a flow chart setting forth the general stages involved in a method 200 consistent with embodiments of the disclosure providing a multi-link procedure to identify link disablement in Basic Service Set (BSS) transition management frames. Method 200 may be implemented using computing device 400 as described in more detail below with respect to FIG. 4. Computing device 400 may be embodied by first AP 115. Ways to implement the stages of method 200 will be described in greater detail below.

Method 200 may begin at starting block 205 and proceed to stage 210 where first AP 115 may receive a Basic Service Set (BSS) Transition Management (BTM) query. First client device 130 may send first AP 115 a BTM query that may solicit a BTM request. For example, if a Received Signal Strength Indicator (RSSI) of the currently associated AP is too low or first client device 130 discovered a better AP, first client device 130 may send a BTM query to the associated AP (e.g., first AP 115). Upon receiving the query, the AP may respond with a BTM request as described below. In other embodiments, the BTM request may be unsolicited. For example, if first AP 115 detects that the RSSI of first client device 130 is lower than the RSSI threshold, it may send the BTM request to first client device 130 unsolicited.

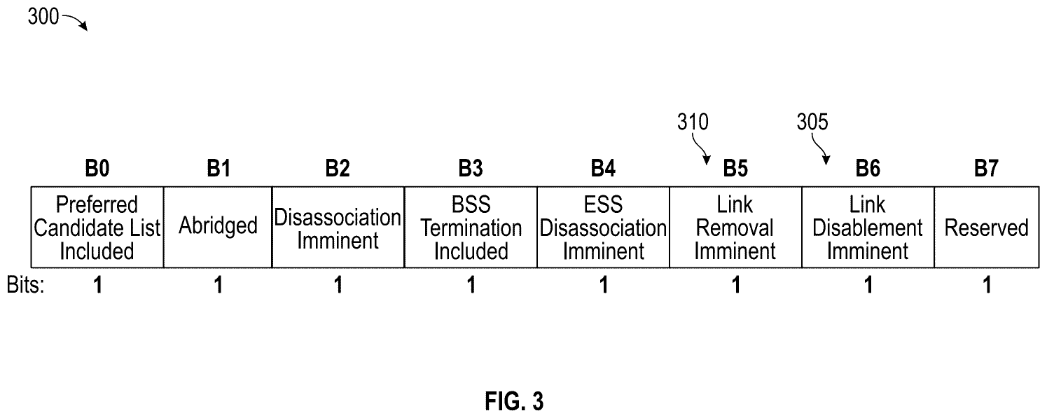

From stage 210, where first AP 115 receives the BTM query, method 200 may advance to stage 220 where first AP 115 may create a BTM request. The BTM request may indicate a link disablement that will happen in the future. For example, FIG. 3 illustrates a Request Mode field format 300. Embodiments of the disclosure may provide a bit in the BSS Transition Management (BTM) Request frame to indicate to non-AP MLDs that the BTM request sent by the affiliated AP is for a link disablement that will happen in the future. The Request Mode field format 300 in the BTM Request frame may be enhanced by adding a Link Disablement Imminent subfield 305 as shown in FIG. 3.

When the link corresponding to an affiliated AP of an AP MLD is getting disabled, the affiliated AP may set the Link Disablement Imminent subfield 305 to 1 in the BTM Request frame that the AP transmits. In one embodiment, to minimize disruption for EHT client devices deployed before this protocol is defined, the affiliated AP may also set a Link Removal Imminent subfield 310 to 1 in that BTM request, because those devices may not understand the Link Disablement Imminent subfield 305. In another embodiment, the Link Removal Imminent subfield 310 may not be set to 1 for link disablement (e.g., for deployments where all devices may understand the Link Disablement Imminent subfield 305). In another embodiment, the AP MLD may ensure that it performs Advertised Traffic Identifier (TID)-to-Link mapping (T2LM) before the AP MLD sends this BTM request so that most associated non-AP MLDs should no longer be listening to the about-to-be-disabled affiliated AP and then most may miss the BTM request. However, there may be non-AP MLDs that are actively using the link until it gets disabled even after the Advertised T2LM, and those non-AP MLDs may receive the BTM request.

In the BTM request, the affiliated AP (e.g., first AP 115) may indicate the time duration for which the link may be disabled in a Duration subfield of the BSS Termination Duration sub-element included in the BTM request frame (for legacy devices to determine for how long the BSS will be gone). The Duration subfield may be set based on the Expected Duration field of the Advertised T2LM for that link disablement.

A non-MLD client may just see a conventional IEEE 802.11v BTM request and may proceed as usual. A “Wi-Fi7R1” non-AP MLD (i.e., one deployed before this protocol is defined), depending on the embodiments followed above, may miss the BTM request or may detect the BTM request and consume the Link Removal Imminent subfield 310, but not the Link Disablement Imminent subfield 305 (e.g., because for that generation of clients, it may be reserved), and may end up gracefully removing the link. A “>Wi-Fi7R1” non-AP MLD (i.e., one deployed and after this protocol is defined), when receiving a BTM request frame from an AP with the Link Disablement Imminent subfield 305 set to 1, may determine that the BTM request is for the disablement of the link corresponding to that AP. Note that the non-AP MLD may retrieve details about the link disablement (e.g., switch time when the link gets disabled and expected duration of link disablement) from the advertised TID-To-Link Mapping element received from Beacon or Probe Response frames.

An AP MLD may suggest BSS Transition Candidates in the BTM request frame transmitted for the link disablement scenario for non-AP MLDs, for example, in following cases: i) for those non-AP MLDs that have only a single link setup with the AP MLD and enable such non-AP MLDs to (re) associate with another preferred AP MLD or perhaps with the current AP MLD but on a different link; and ii) for those non-AP MLDs that have dual link setup with the AP MLD including the soon-to-be disabled link and enable such non-AP MLDs to (re) associate with another preferred AP MLD to maintain multi-link operation, or perhaps with the current AP MLD on a different set of dual links. Having an explicit link disablement indication in the BTM request frame may ensures that the >Wi-Fi7R1 non-AP MLD does not misinterpret the BTM request in the link disablement scenario to mean a link removal or even worse, the shutting down of the entire AP MLD.

Once first AP 115 creates the BTM request in stage 220, method 200 may continue to stage 230 where first AP 115 may send the BTM request. For example, first client device 130 may receive the BTM request sent by first AP 115. As stated above the request may be solicited or unsolicited.

After first AP 115 sends the BTM request in stage 230, method 200 may proceed to stage 240 where first AP 115 may receive a BTM response. For example, upon receiving the BTM request, first client device 130 may determine whether to disconnect from first AP 115 and roam to a recommended AP. If first client device 130 determines to perform a roaming, it may send the BTM response to first AP 115. If first client device 130 fails to leave the current BSS before the disassociation timer expires, first AP 115 may send a disassociation request to first client device 130 and may log off first client device 130. Once first AP 115 receives the BTM response in stage 240, method 200 may then end at stage 250.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing a multi-link procedure to identify link disablement in Basic Service Set (BSS) transition management frames as described above with respect to FIG. 2. Computing device 400, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
creating a Basic Service Set (BSS) Transition Management (BTM) request, wherein the BTM request indicates a future link disablement that will happen; and
sending the BTM request.

2. The method of claim 1, wherein the BTM request indicates the future link disablement that will happen in a Request Mode Field in a BTM Request frame.

3. The method of claim 1, wherein the BTM request indicates the future link disablement that will happen in a Link Disablement Imminent subfield in a Request Mode Field in a BTM Request frame.

4. The method of claim 1, wherein creating the BTM request further comprises setting a Disassociation Imminent subfield to a value of 1 in a BTM Request frame.

5. The method of claim 1, wherein creating the BTM request further comprises setting a BSS Termination Included subfield to a value of 0 or a value of 1 in a BTM Request frame.

6. The method of claim 1, wherein creating the BTM request further comprises setting a Link Removal Imminent subfield to a value of 0 or a value of 1 in a BTM Request frame.

7. The method of claim 1, wherein the BTM request further indicates a duration of the future link disablement that will happen.

8. The method of claim 1, wherein the BTM request further indicates the duration of the future link disablement that will happen in a Duration subfield of a BSS Termination Duration subfield.

9. The method of claim 8, wherein the Duration subfield is set based on a duration advertised for a future link disablement in a Beacon frame.

10. The method of claim 1, wherein the BTM request further includes suggestion for BSS transition candidates to use for association when the future link disablement will happen.

11. The method of claim 1, wherein sending the BTM request comprises sending the BTM request as a broadcast message.

12. The method of claim 1, further comprising:
receiving a BTM query; and
creating the BTM request in response to receiving the BTM query.

13. The method of claim 1, wherein the BTM request comprises an unsolicited request.

14. The method of claim 1, further comprising receiving a BTM response.

15. A system comprising:
a memory storage; and
a processing unit coupled to the memory storage, wherein the processing unit is operative to:
create a Basic Service Set (BSS) Transition Management (BTM) request, wherein the BTM request indicates a future link disablement that will happen; and
send the BTM request.

16. The system of claim 15, wherein the BTM request indicates the future link disablement that will happen in a Request Mode Field in a BTM Request frame.

17. The system of claim 15, wherein the BTM request indicates the future link disablement that will happen in a Link Disablement Imminent subfield in a Request Mode Field in a BTM Request frame.

18. A non-transitory computer-readable medium that stores a set of instructions which when executed perform a method executed by the set of instructions comprising:
creating a Basic Service Set (BSS) Transition Management (BTM) request, wherein the BTM request indicates a future link disablement that will happen; and
sending the BTM request.

19. The non-transitory computer-readable medium of claim 13, wherein the BTM request indicates the future link disablement that will happen in a Request Mode Field in a BTM Request frame.

20. The non-transitory computer-readable medium of claim 13, wherein the BTM request indicates the future link disablement that will happen in a Link Disablement Imminent subfield in a Request Mode Field in a BTM Request frame.
